(19) United States
(12) Patent Application Publication
(10) Pub. No.: US 2021/0186222 A1
(43) Pub. Date: Jun. 24, 2021

(54) OBLIQUE HINGED PANELS AND BLADDER APPARATUS FOR SLEEP DISORDERS

(71) Applicant: Hill-Rom Services, Inc., Batesville, IN (US)

(72) Inventors: Ibne Soreefan, West Chester, OH (US); David L. Ribble, Batesville, IN (US); Kirsten M. Emmons, Batesville, IN (US); Craig M. Meyerson, Syracuse, NY (US); David Quinn, Auburn, NY (US); Thomas F. Heil, Batesville, IN (US)

(21) Appl. No.: 17/191,884

(22) Filed: Mar. 4, 2021

Related U.S. Application Data
(63) Continuation of application No. 16/787,331, filed on Feb. 11, 2020, now Pat. No. 10,959,534.
(60) Provisional application No. 62/811,605, filed on Feb. 28, 2019.

(51) Int. Cl. A47C 20/04; A47C 19/02

(52) U.S. Cl. CPC A47C 20/048; A47C 20/04; A47C 19/025; A47C 19/022

(57) ABSTRACT

A head elevation apparatus configured to be positioned under a mattress may include a base panel and a top panel positioned on the base panel. The top panel may include a center panel hingedly coupled to the base panel. An upper flap may be hingedly coupled to the center panel. A lower flap may be hingedly coupled to the center panel.

### CROSS-REFERENCE TO RELATED APPLICATIONS

The present application is a continuation of U.S. application Ser. No. 16/787,331, filed Feb. 11, 2020, now U.S. Pat. No. ______, which claims the benefit, under 35 U.S.C. § 119(e), of U.S. Provisional Application 62/811,605, filed Feb. 28, 2019, each of which is expressly incorporated by reference herein.

### BACKGROUND

The present disclosure relates to a head elevation apparatus, and more particularly, to a head elevation apparatus having panels to laterally rotate a person's head and torso to treat sleep disorders.

The subject matter disclosed herein relates generally to adverse event mitigation devices, systems, and methods and, more particularly, but not exclusively, to devices, systems, and methods for the prevention and treatment of sleep apnea. The embodiments described herein may also be effective in reducing snoring. While various adverse event mitigation devices, systems, and methods have been developed, there is still room for improvement. Thus, a need persists for further contributions in this area of technology.

### SUMMARY

The present disclosure includes one or more of the features recited in the appended claims and/or the following features which, alone or in any combination, may comprise patentable subject matter.

According to an aspect of the disclosed embodiments, a head elevation apparatus configured to be positioned under a mattress may include a base panel. A top panel may be positioned on the base panel. The top panel may include a center panel hingedly coupled to the base panel. An upper flap may be hingedly coupled to the center panel. A lower flap may be hingedly coupled to the center panel. The center panel may be configured to move between a collapsed position and a raised position relative to the base panel. When the center panel is moved to the raised position, the upper flap and the lower flap may rotate relative to the center panel.

In some embodiments, the center panel may be hingedly coupled to the base panel along a center hinge that may extend at a first oblique angle relative to a front face of the base panel. The upper panel may be hingedly coupled to the center panel along an upper hinge that may extend at a second oblique angle relative to the front face. The upper hinge may extend at a third oblique angle relative to the center hinge. The lower panel may be hingedly coupled to the center panel along a lower hinge that may extend at a fourth oblique angle relative to the front face. The lower hinge may extend at a fifth oblique angle relative to the center hinge. The upper panel may be hingedly coupled to the center panel along an upper hinge. The lower panel may be hingedly coupled to the center panel along a lower hinge. The lower hinge may extend at a sixth oblique angle relative to the upper hinge.

Optionally, moving the center panel to the raised position may alter a lateral angle of the mattress. The center panel may be movable to a plurality of intermediate positions between the collapsed position and the raised position. The lateral angle of the mattress may be different at each intermediate position.

Alternatively or additionally, a bladder may be positioned between the base panel and the center panel. The bladder may be inflatable and deflatable to move the center panel between the collapsed position and the raised position. The bladder may include a lower bladder and an upper bladder coupled to the lower bladder. The upper bladder may be positioned adjacent the center panel. The lower bladder may be positioned adjacent the base panel.

It may be desired that the base panel may include a lower panel and an upper panel. The upper panel may be hingedly coupled to the lower panel and configured to move between a retracted positioned and an extended position. The upper panel may move to the extended position to alter a longitudinal angle of the mattress. The upper panel may be movable to a plurality of intermediate positions between the retracted positioned and the extended position. A bladder may be positioned between the upper panel and the lower panel. The bladder may be inflatable and deflatable to move the upper panel between the retracted position and the extended position. The bladder may include an upper bladder and a lower bladder coupled to the upper bladder. The upper bladder may be positioned adjacent the upper panel. The lower bladder may be positioned adjacent the lower panel.

According to another aspect of the disclosed embodiments, a head elevation apparatus configured to be positioned under a mattress may include a base panel. A top panel may be positioned on the base panel. The top panel may include a center panel hingedly coupled to the base panel along a center hinge that may extend at a first oblique angle relative to a front face of the base panel. An upper flap may be hingedly coupled to the center panel along an upper hinge that may extend at a second oblique angle relative to the front face. The upper hinge may extend at a third oblique angle relative to the center hinge. A lower flap may be hingedly coupled to the center panel along a lower hinge that may extend at a fourth oblique angle relative to the front face. The lower hinge may extend at a fifth oblique angle relative to the center hinge. The center panel may be configured to move between a collapsed position and a raised position relative to the base panel. When the center panel is moved to the raised position, the upper flap and the lower flap may rotate relative to the center panel. In some embodiments, the lower hinge may extend at a sixth oblique angle relative to the upper hinge.

Optionally, moving the center panel to the raised position may alter a lateral angle of the mattress. The center panel may be movable to a plurality of intermediate positions between the collapsed position and the raised position. The lateral angle of the mattress may be different at each intermediate position.

Additionally or alternatively, a bladder may be positioned between the base panel and the center panel. The bladder may be inflatable and deflatable to move the center panel between the collapsed position and the raised position. The bladder may include a lower bladder and an upper bladder coupled to the lower bladder. The upper bladder may be positioned adjacent the center panel. The lower bladder may be positioned adjacent the base panel.

It may be contemplated that the base panel may include a lower panel and an upper panel. The upper panel may be hingedly coupled to the lower panel and configured to move between a retracted positioned and an extended position. The upper panel may move to the extended position to alter a longitudinal angle of the mattress. The upper panel may be movable to a plurality of intermediate positions between the retracted positioned and the extended position. A bladder may be positioned between the upper panel and the lower panel. The bladder may be inflatable and deflatable to move the upper panel between the retracted position and the extended position. The bladder may include an upper bladder and a lower bladder coupled to the upper bladder. The upper bladder may be positioned adjacent the upper panel. The lower bladder may be positioned adjacent the lower panel.

According to yet another aspect of the disclosed embodiments, a head elevation apparatus configured to be positioned under a mattress may include a base panel. A top panel may be positioned on the base panel. The top panel may include a center panel hingedly coupled to the base panel along a center hinge. An upper flap may be hingedly coupled to the center panel along an upper hinge. A lower flap may be hingedly coupled to the center panel along a lower hinge. The center panel may be configured to move between a collapsed position and a raised position relative to the base panel. When the center panel is moved to the raised position, the upper flap and the lower flap may rotate relative to the center panel.

In some embodiments, the center hinge may extend at a first oblique angle relative to a front face of the base panel. The upper hinge may extend at a second oblique angle relative to the front face. The upper hinge may extend at a third oblique angle relative to the center hinge. The lower hinge may extend at a fourth oblique angle relative to the front face. The lower hinge may extend at a fifth oblique angle relative to the center hinge. The lower hinge may extend at a sixth oblique angle relative to the upper hinge.

Additionally or alternatively, moving the center panel to the raised position may alter a lateral angle of the mattress. The center panel may be movable to a plurality of intermediate positions between the collapsed position and the raised position. The lateral angle of the mattress may be different at each intermediate position.

Optionally, a bladder may be positioned between the base panel and the center panel. The bladder may be inflatable and deflatable to move the center panel between the collapsed position and the raised position. The bladder may include a lower bladder and an upper bladder coupled to the lower bladder. The upper bladder may be positioned adjacent the center panel. The lower bladder may be positioned adjacent the base panel.

It may be contemplated that the base panel may include a lower panel and an upper panel. The upper panel may be hingedly coupled to the lower panel and may be configured to move between a retracted positioned and an extended position. The upper panel may move to the extended position to alter a longitudinal angle of the mattress. The upper panel may be movable to a plurality of intermediate positions between the retracted positioned and the extended position. A bladder may be positioned between the upper panel and the lower panel. The bladder may be inflatable and deflatable to move the upper panel between the retracted position and the extended position. The bladder may include an upper bladder and a lower bladder coupled to the upper bladder. The upper bladder may be positioned adjacent the upper panel. The lower bladder may be positioned adjacent the lower panel.

According to a further aspect of the disclosed embodiments, a head elevation apparatus configured to be positioned under a mattress may include a base panel. A top panel may be positioned on the base panel. The top panel may include a center panel hingedly coupled to the base panel. An upper flap may be hingedly coupled to the center panel. A lower flap may be hingedly coupled to the center panel. A first bladder may be positioned between the center panel and the base panel. A blower may be coupled to the first bladder to inflate and deflate the first bladder. The center panel may be configured to move between a collapsed position and a raised position relative to the base panel when the first bladder is inflated and deflated. When the center panel is moved to the raised position, the upper flap and the lower flap may rotate relative to the center panel.

In some embodiments, the center panel may be hingedly coupled to the base panel along a center hinge that may extend at a first oblique angle relative to a front face of the base panel. The upper panel may be hingedly coupled to the center panel along an upper hinge that may extend at a second oblique angle relative to the front face. The upper hinge may extend at a third oblique angle relative to the center hinge. The lower panel may be hingedly coupled to the center panel along a lower hinge that may extend at a fourth oblique angle relative to the front face. The lower hinge may extend at a fifth oblique angle relative to the center hinge. The upper panel may be hingedly coupled to the center panel along an upper hinge. The lower panel may be hingedly coupled to the center panel along a lower hinge. The lower hinge may extend at a sixth oblique angle relative to the upper hinge.

Optionally, moving the center panel to the raised position may alter a lateral angle of the mattress. The center panel may be movable to a plurality of intermediate positions between the collapsed position and the raised position. The lateral angled of the mattress may be different at each intermediate position.

It may be desired that the base panel may include a lower panel and an upper panel. The upper panel may be hingedly coupled to the lower panel and may be configured to move between a retracted positioned and an extended position. The upper panel may move to the extended position to alter a longitudinal angle of the mattress. The upper panel may be movable to a plurality of intermediate positions between the retracted positioned and the extended position. A second bladder may be positioned between the upper panel and the lower panel. The second bladder may be inflatable and deflatable to move the upper panel between the retracted position and the extended position.

According to yet a further aspect of the disclosed embodiments, a head elevation apparatus configured to be positioned under a mattress may include a base panel that may have a lower panel and an upper panel. The upper panel may be hingedly coupled to the lower panel and may be configured to move between a retracted positioned and an extended position. A top panel may be positioned on the base panel. The top panel may include a center panel hingedly coupled to the base panel. The center panel may be configured to move between a collapsed position and a raised position relative to the base panel. An upper flap may be hingedly coupled to the center panel. A lower flap may be hingedly coupled to the center panel. A first bladder may be positioned between the center panel and the base panel. A second bladder may be positioned between the upper panel and the lower panel. When the center panel is moved to the raised position, the upper flap and the lower flap may rotate relative to the center panel to alter a lateral angle of the mattress. The upper panel may move to the extended position to alter a longitudinal angle of the mattress.

Optionally, the center panel may be hingedly coupled to the base panel along a center hinge that may extend at a first oblique angle relative to a front face of the base panel. The upper panel may be hingedly coupled to the center panel along an upper hinge that may extend at a second oblique angle relative to the front face. The upper hinge may extend at a third oblique angle relative to the center hinge. The lower panel may be hingedly coupled to the center panel along a lower hinge that may extend at a fourth oblique angle relative to the front face. The lower hinge may extend at a fifth oblique angle relative to the center hinge. The upper panel may be hingedly coupled to the center panel along an upper hinge. The lower panel may be hingedly coupled to the center panel along a lower hinge. The lower hinge may extend at a sixth oblique angle relative to the upper hinge.

Additionally or alternatively, the center panel may be movable to a plurality of intermediate positions between the collapsed position and the raised position. The lateral angle of the mattress may be different at each intermediate position. The upper panel may be movable to a plurality of intermediate positions between the retracted positioned and the extended position.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a top perspective view of a head elevation apparatus that includes a top panel hingedly coupled to a base panel, wherein the top panel is illustrated in a collapsed position;

FIG. 2 is a top perspective view of the head elevation apparatus, wherein the top panel is illustrated in a raised position;

FIG. 3 is a top plan view of the head elevation apparatus is the collapsed position and positioned on a patient support apparatus;

FIG. 4 is a rear perspective view of the head elevation apparatus, wherein a center panel is raised to the raised position by a bladder and an upper flap and a lower flap are folded inward toward the center panel;

FIG. 5 is a side perspective view of the head elevation apparatus showing the top panel raised relative to the base panel by the bladder and an upper panel of the base panel raised relative to a lower panel of the base panel by another bladder;

FIG. 6 is an opposite side perspective view of the head elevation apparatus showing the top panel raised relative to the base panel by the bladder and the upper panel of the base panel raised relative to the lower panel of the base panel by the other bladder;

FIG. 7 is a rear perspective view of the head elevation apparatus showing the top panel raised relative to the base panel by the bladder and the upper panel of the base panel raised relative to the lower panel of the base panel by the other bladder; and

FIG. 8 is a front perspective view of the head elevation apparatus in a raised position to alter a lateral and longitudinal angle of a mattress positioned over a patient support apparatus.

### DETAILED DESCRIPTION

Referring to FIG. 1, a head elevation apparatus 100 includes a front end 102 and a back end 104. A pair of side ends 106 extend between the front end 102 and the back end 104. The apparatus 100 includes a base panel 108 that is divided into a left side 110 and a right side 112 by a center line 114. The base panel 108 extends between the front end 102 and the back end 104. The base panel 108 also extends between the side ends 106. A top panel 120 is positioned over the right side 112 of the base panel 108. It should be appreciated that the top panel 120 may be positioned over the left side 110 of the base panel 108. In some embodiments, the apparatus 100 may include a top panel 120 positioned over each of the right side 112 and the left side 110 of the base panel 108. In some embodiments, the apparatus 100 may only include the right side 112 or the left side 110.

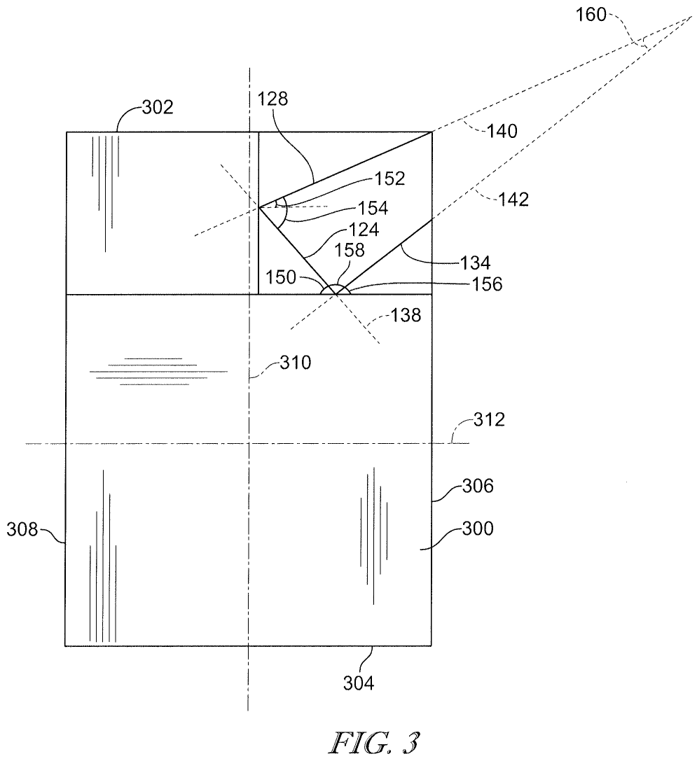

The top panel 120 includes a center panel 122 that is hingedly coupled to the base panel 108 along a center hinge 124 for pivoting movement about a first axis 138 (shown in FIG. 3). An upper flap 126 is hingedly coupled to the center panel 122 along an upper hinge 128 for pivoting movement about a second axis 140 (shown in FIG. 3). The remaining sides 130 of the upper flap 126 are not coupled to anything so that the upper flap 126 can move freely relative to the base panel 108 as the center panel 122 is raised and lowered. The upper flap 126 is triangular is shaped; however, it will be appreciated that the upper flap 126 may be formed with other shapes. In some embodiments, the upper flap 126 is a scalene triangle. A lower flap 132 is hingedly coupled to the center panel 122 along a lower hinge 134 for pivoting movement about a third axis 142 (shown in FIG. 3). The remaining sides 136 of the lower flap 132 are not coupled to anything so that the lower flap 132 can move freely relative to the base panel 108 as the center panel 122 is raised and lowered. The lower flap 132 is triangular in shape; however, it will be appreciated that the lower flap 132 may be formed with other shapes. In some embodiments, the lower flap 132 is a scalene triangle.

In some embodiments, hinges 124, 128, and 134 include piano hinges having hinge plates interconnected by a hinge pin that defines the respective axes 138, 140, and 142 of the hinges 124, 128, and 134. In other embodiments, living hinges made of strips of flexible material, such as plastic material or cloth material, are used as hinges 124, 128, and 134.

The first axis 138 of the center hinge 124 extends at an oblique angle 150 relative to the front end 102. In some embodiments, the angle 150 is approximately 45 degrees. The first axis 138 of the center hinge 124 also extends at oblique angles (not shown) relative to the back end 104 and the side ends 106. The second axis 140 of the upper hinge 128 extends at an oblique angle 152 relative to the front end 102. In some embodiments, the angle 152 is approximately 23 degrees. The second axis 140 of the upper hinge also extends at oblique angles (not shown) relative to the back end 104 and the side ends 106. The second axis 140 of the upper hinge 128 extends at an oblique angle 154 relative to the first axis 138 of the center hinge 124. In some embodiments, the angle 154 is approximately 68 degrees. The third axis 142 of the lower hinge 134 extends at an oblique angle 156 relative to the front end 102. In some embodiments, the angle 156 is approximately 55.2 degrees. The third axis 142 of the lower hinge 134 also extends at oblique angles (not shown) relative to the back end 104 and the side ends 106. The third axis 142 of the lower hinge 134 extends at an oblique angle 158 relative to the first axis 138 of the center hinge 124. In some embodiments, the angle 158 is approximately 79.8 degrees. The third axis 142 of the lower hinge 134 also extends at an oblique angle 160 relative to the second axis 140 of the upper hinge 128. In some embodiments, the angle 160 is approximately 11.8 degrees. It will be appreciated, that the angles 150, 152, 154, 156, 158, and 160 may be altered to alter a configuration of the head elevation apparatus 100. In this disclosure, the term “oblique” means neither perpendicular nor parallel.

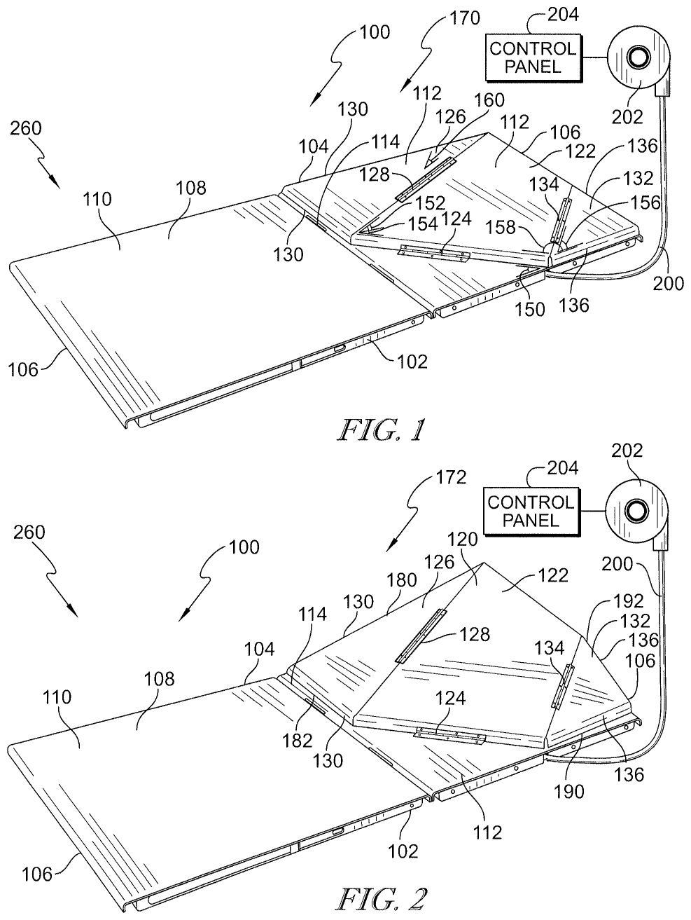

The center panel 122 is configured to move between a collapsed position 170 (shown in FIG. 1) and a raised position 172 (shown in FIG. 3). Referring now to FIG. 2, the center panel 122 rotates about the first axis 138 of the center hinge 124 to the raised position 172 relative to the base panel 108. When the center panel 122 is raised, the upper flap 126 rotates about the second axis 140 of the upper hinge 128 so that a free end 180 of the upper flap 126 moves inward away from the back end 104. Another free end 182 of the upper flap 126 moves inward away from the center line 114. The degree to which the free ends 180, 182 move is dependent on how high the center panel 122 is raised. In the collapsed position 170, the free end 180 is substantially co-planar with the back end 104 and the free end 182 is substantially co-planar with the center line 114. At the raised position 172, the free ends 180 and 182 are moved to maximum inward positions. If the center panel 122 is raised to an intermediate position between the collapsed position 170 and the raised position 172, the free end 180 is moved to an intermediate position between the back end 104 and the maximum position and the free end 182 is moved to an intermediate position between the center line 114 and the maximum position.

When the center panel 122 is raised, the lower flap 132 rotates about the third axis 142 of the lower hinge 134 so that a free end 190 of the lower flap 132 moves inward away from the front end 102. Another free end 192 of the lower flap 132 moves inward away from the side end 106. The degree to which the free ends 190, 192 move is dependent on how high the center panel 122 is raised. In the collapsed position 170, the free end 190 is substantially co-planar with the front end 102 and the free end 192 is substantially co-planar with the side end 106. At the raised position 172, the free ends 190 and 192 are moved to maximum inward positions. If the center panel 122 is raised to an intermediate position between the collapsed position 170 and the raised position 172, the free end 190 is moved to an intermediate position between the front end 102 and the maximum position and the free end 192 is moved to an intermediate position between the side end 106 and the maximum position.

Referring to both FIGS. 1 and 2, the center panel 122 is raised and lowered by a bladder (described in more detail below). That is, the bladder is inflated and deflated to move the center panel 122 between the collapsed position 170 and the raised position 172. As illustrated in FIGS. 1 and 2, a hose 200 extends from the bladder to a blower 202. The blower 202 is operable to inflate and deflate the bladder to raise and lower the center panel 122 between the collapsed position 170 and the raised position 172. A controller 204 may be coupled to the blower 202 to control the blower 202. The controller 204 may include inputs that allow a user to inflate or deflate the bladder to position the center panel 122 at the collapsed position 170, the raised position 172, or a desired intermediate position between the collapsed position 170 and the raised position 172.

In some embodiments, the controller 204 is separate from the blower 202 (as illustrated) and may be positioned adjacent a patient support apparatus. In other embodiments, the controller 204 may be incorporated into a housing of the blower 202. In yet another embodiment, the controller 204 may be a pendant that a user can operate while positioned on a patient support apparatus. Accordingly, the user may adjust a height of the center panel 122 while positioned on the patient support apparatus and supported by the head elevation apparatus 100.

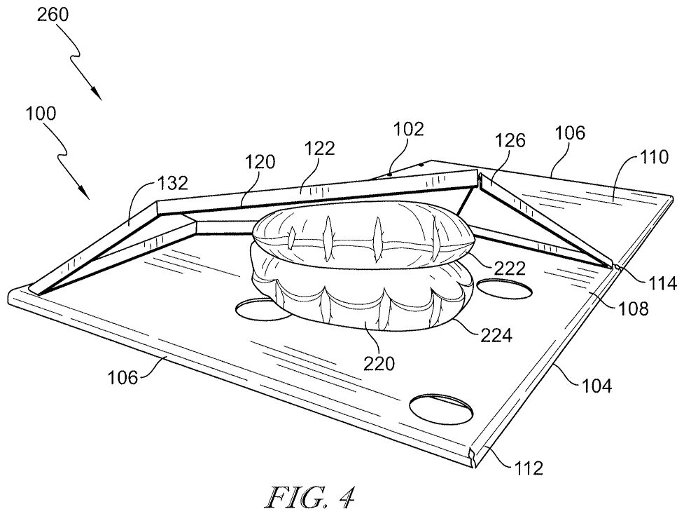

Referring to FIG. 4, a bladder 220 is positioned between the base panel 108 and the top panel 120. The bladder 220 extends between the base panel 108 and the center panel 122. The bladder 220 is illustrated with an upper bladder 222 and a lower bladder 224. The upper bladder 222 is positioned above the lower bladder 224. The upper bladder 222 and the lower bladder 224 are in fluid communication. The combination of the upper bladder 222 and the lower bladder 224 facilitates balancing the center panel 122 on the bladder 220. It should be noted that the bladder 220 may include any number of bladder sections, including only one bladder section. The upper bladder 222 is positioned adjacent to and in contact with the center panel 122. The lower bladder 224 is positioned adjacent to and in contact with the base panel 108.

As the bladder 220 is inflated, the center panel 122 raises relative to the base panel 108. The bladder 220 may be inflated to any desired pressure to raise the center panel 122 to a desired intermediate position between the collapsed position 170 and the raised position 172. As illustrated in FIG. 3, when the center panel 122 is raised, the upper flap 126 is rotated inward. Likewise, the lower flap 132 is rotated inward when the center panel 122 is raised. In some embodiments, at least one of the upper flap 126 and the lower flap 132 may rotate into contact with the bladder 220 to inhibit further inward movement of the upper flap 126 and the lower flap 132. However, as illustrated in FIG. 3, the upper flap 126 and the lower flap 132 do not need to contact the bladder 220 to maintain a respective position of the upper flap 126 and the lower flap 132.

FIG. 4 illustrates a single bladder 220 configured to raise and lower the center panel 122. It will be appreciated that the apparatus 100 may include any number of bladders 220 to raise and lower the center panel 122. For example, an array of bladders 220 may be configured to raise and lower the center panel 122. In such an embodiment, each bladder 220 of the array of bladders 220 may be inflated to a different pressure to balance the center panel 122. In other embodiments, an actuator other than the bladder 220 may be utilized to raise and lower the center panel 122. For example, the center panel 122 may be raised and lowered by a hydraulic mechanism.

Referring to FIG. 5, in some embodiments, the base panel 108 includes an upper panel 250 and a lower panel 252. The upper panel 250 is hingedly attached to the lower panel 252 along a base hinge 254 that extends along the front end 102. The center hinge 124 extends at the oblique angle 150 relative to the base hinge 254. The upper hinge 128 extends at the oblique angle 152 relative to the base hinge 254. The lower hinge 134 extends at the oblique angle 156 relative to the base hinge 254.

The upper panel 250 may be raised and lowered between a retracted position 260 (shown in FIGS. 1-4) and an extended position 262 (shown in FIGS. 5-8) relative to the lower panel 252. A bladder 270 is positioned between the upper panel 250 and the lower panel 252. The bladder 270 is inflated and deflated to raise and lower the upper panel 250 between the retracted position 260 and the extended position 262. The bladder 270 may also be inflated and deflated to a pressure that positions the upper panel 250 at an intermediate position between the retracted position 260 and the extended position 262. The bladder 270 may be inflated and deflated by the blower 202. That is the blower 202 may inflate and deflate the bladder 270 and the bladder 220 simultaneously. Optionally, a valve (not shown) may be provided to directed airflow from the blower 202 to one of the bladder 270 or the bladder 220. In some embodiments, the apparatus 100 may include two blowers 202, wherein each blower 202 operates one of the bladders 220 and 270. The controller 204 may be utilized to control the inflation and deflation of each of the bladders 220 and 270. The bladder 270 is illustrated as having a single section; however, the bladder 270 may include any number of sections.

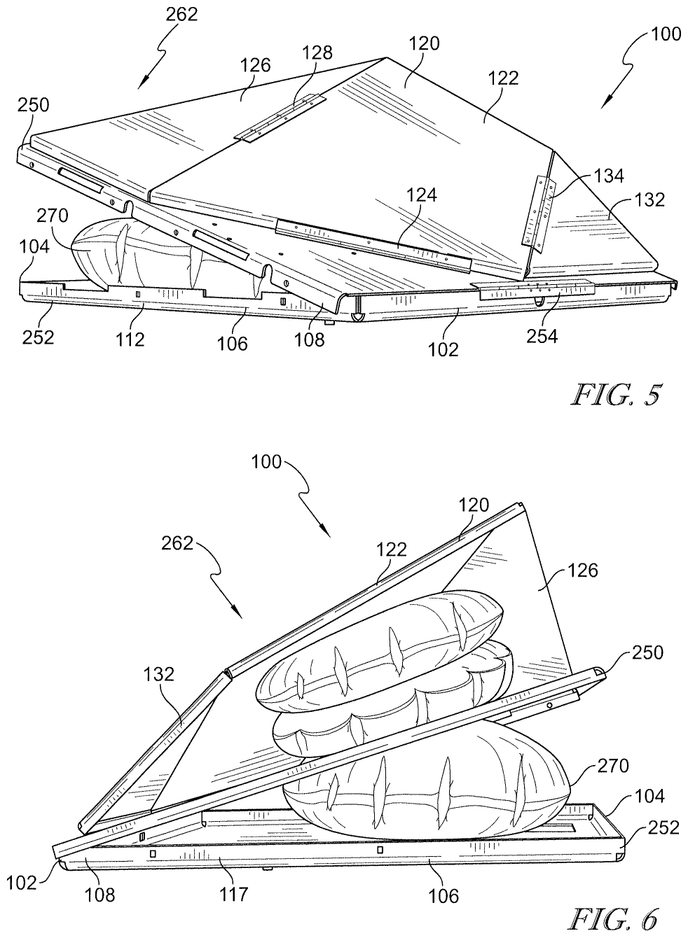

As illustrated in FIG. 6, both bladders 220 and 270 may be operated at the same time. That is, the bladder 220 may be inflated to raise the center panel 122, while the bladder 270 is operated to raise the upper panel 250. The center panel 122 is raised and lowered to alter a lateral angle of the apparatus 100, whereas the upper panel 250 is raised and lowered to alter a longitudinal angle of the apparatus 100. By adjusting the bladder 220 and the bladder 270 at the same time, both the later angle and the longitudinal angle of the apparatus 100 are adjusted. However, the bladder 220 may be adjusted alone to adjust only the lateral angle. Likewise, the bladder 270 may be adjusted alone to alter only the longitudinal angle. When operating the apparatus 100, both the bladder 220 and the bladder 270 may be inflated or deflated to different intermediate positions to provide a desired lateral angle and a desired longitudinal angle.

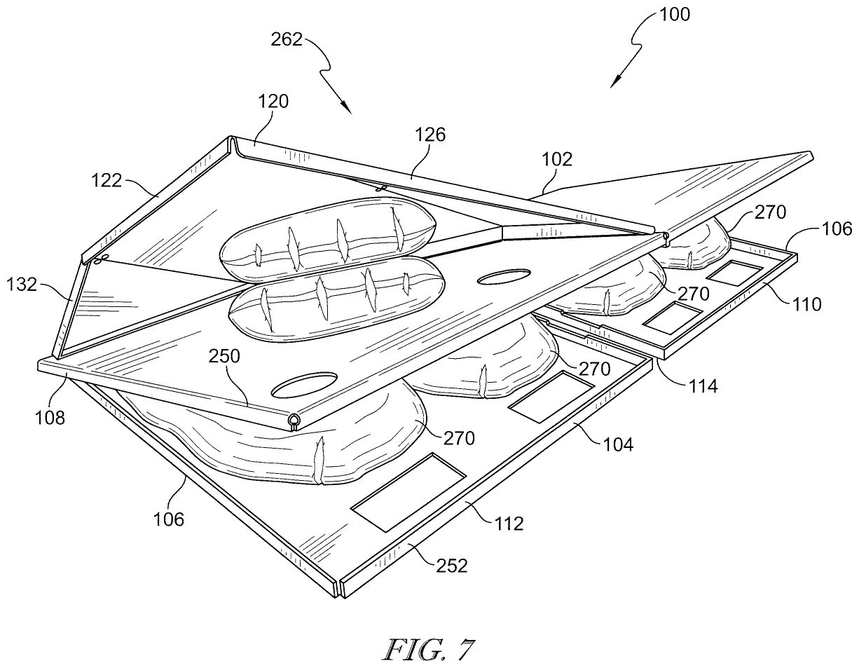

Referring to FIG. 7, the apparatus 100 includes two bladders 270 on the right side 112 and two bladder 270 on the left side 110. Accordingly, each of the sides 112 and 110 of the apparatus 100 may be raised and lowered. Notably, each side 110 and 112 may include any number of bladders 270, for example one. As illustrated, the bladders 270 may all be adjusted to alter a longitudinal angle of both sides 110 and 112. Additionally, the right side 112 also includes the top panel 120. The center panel 122 of the top panel 120 may also be raised and lowered to alter the lateral angle of the right side 112.

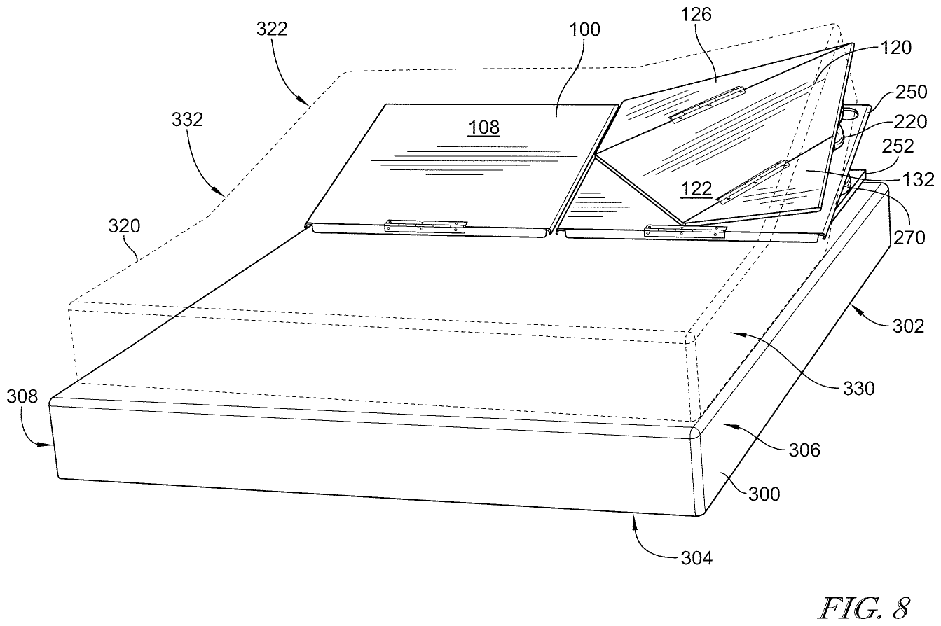

FIG. 8 illustrates a patient support apparatus 300 having a head end 302 and a foot end 304. A right side 306 and a left side 308 extend between the head end 302 and the foot end 304. A longitudinal axis 310 (shown in FIG. 3) extends from the head end 302 to the foot end 304. A lateral axis 312 (shown in FIG. 3) extends from the right side 306 to the left side 308. The apparatus 100 is positioned at the head end 302 of the patient support apparatus 300. A mattress 320 having a head end 322 is positioned over the patient support apparatus 300 so that the apparatus 100 is positioned between the head end 302 of the patient support apparatus 300 and the head end 322 of the mattress 320. The head end 322 of the mattress 320 includes a right side 330 and a left side 332. The right side 330 of the mattress 320 is positioned over the right side 112 of the apparatus 100, and the left side 332 of the mattress 320 is positioned over the left side 110 of the apparatus 100.

In the illustrated embodiment, the upper panel 250 is illustrated in the extended position 262 to raise the head end 322 of the mattress 320 and alter a longitudinal angle of the head end 322 of the mattress 320. Also, the center panel 122 is raised to the raised position 172 to alter a lateral angle of the right side 330 of the mattress 320. It should be noted that only the center panel 122 may be raised to the raised position 172 to alter the lateral angle, while the upper panel 250 is in the retracted position 260. Likewise, only the upper panel 250 may be raised to the extended position 262 to alter the longitudinal angle, while the center panel 122 is in the collapsed position 170. As set forth above, both the center panel 122 and the upper panel 250 may be raised or lowered to intermediate positions where in each of the lateral angles and the longitudinal angles are different.

The apparatus 100 provides graduated lateral rotation (GLR) as a therapy for sleep disordered breathing. The apparatus allows GLR to be added to any existing consumer bed that conforms to an adjustable frame (e.g., viscoelastic foam or air bladder) by introducing an adjustable wedge below the mattress in the head and torso sections. The apparatus 100 includes an upper module that creates a lateral angle under the mattress. In another embodiment, the apparatus 100 may also include a lower module to create a longitudinal angle (or “elevated head of bed” position). The upper module can be mounted on the lower module.

The upper module uses a single bladder and a single hinged panel to provide improved comfort by creating a more continuous support of the mattress and reducing variation that could be uncomfortable to users. The apparatus 100 also provides improved mattress wear by supporting the mattress continuously rather than leaving areas of the mattress unsupported, potentially resulting in mattress damage, wear, or breakdown. The lower module supplements the laterally angled surface of the upper module to improved comfort by providing a raised (e.g., 5-15 degree) angle under the laterally angled support. The modular nature of the apparatus 100 also simplifies installation and reduces shipping cost and burden.

Although this disclosure refers to multiple embodiments, it will be appreciated that aspects of each embodiment may be utilized with other embodiments described herein.

Although this disclosure refers to specific embodiments, it will be understood by those skilled in the art that various changes in form and detail may be made without departing from the subject matter set forth in the accompanying claims.

What is claimed is:

1. A head elevation apparatus configured to be positioned under a mattress, the apparatus comprising:
a base panel,
a top panel positioned on the base panel, the top panel comprising:
a center panel hingedly coupled to the base panel,
an upper flap hingedly coupled to the center panel, and
a lower flap hingedly coupled to the center panel,
a first bladder positioned between the center panel and the base panel, and
an air source coupled to the first bladder to inflate and deflate the first bladder,
wherein the center panel is configured to move between a collapsed position and a raised position relative to the base panel when the first bladder is inflated and deflated, and
wherein, when the center panel is moved to the raised position, the upper flap and the lower flap rotate relative to the center panel.

2. The apparatus of claim 1, wherein the center panel is hingedly coupled to the base panel along a center hinge that extends at a first oblique angle relative to a front face of the base panel.

3. The apparatus of claim 2, wherein the upper panel is hingedly coupled to the center panel along an upper hinge that extends at a second oblique angle relative to the front face.

4. The apparatus of claim 3, wherein the upper hinge extends at a third oblique angle relative to the center hinge.

5. The apparatus of claim 2, wherein the lower panel is hingedly coupled to the center panel along a lower hinge that extends at a fourth oblique angle relative to the front face.

6. The apparatus of claim 5, wherein the lower hinge extends at a fifth oblique angle relative to the center hinge.

7. The apparatus of claim 2, wherein
the upper panel is hingedly coupled to the center panel along an upper hinge,
the lower panel is hingedly coupled to the center panel along a lower hinge, and
the lower hinge extends at a sixth oblique angle relative to the upper hinge.

8. The apparatus of claim 1, wherein moving the center panel to the raised position alters a lateral angle of the mattress.

9. The apparatus of claim 8, wherein the center panel is movable to a plurality of intermediate positions between the collapsed position and the raised position, wherein the lateral angle of the mattress is different at each intermediate position.

10. The apparatus of claim 1, wherein the base panel includes a lower panel and an upper panel, the upper panel being hingedly coupled to the lower panel and configured to move between a retracted positioned and an extended position.

11. The apparatus of claim 10, wherein the upper panel moves to the extended position to alter a longitudinal angle of the mattress.

12. The apparatus of claim 11, wherein the upper panel is movable to a plurality of intermediate positions between the retracted positioned and the extended position.

13. The apparatus of claim 10, further comprising a second bladder positioned between the upper panel and the lower panel, the second bladder being inflatable and deflatable to move the upper panel between the retracted position and the extended position.

14. The apparatus of claim 1, wherein the air source comprises a blower.
